(19) United States
(12) Patent Application Publication
(10) Pub. No.: US 2023/0221096 A1
(43) Pub. Date: Jul. 13, 2023

(54) SCOPE MOUNTING ALIGNMENT ASSEMBLY AND RELATED METHOD OF USE

(71) Applicant: Leapers, Inc., Livonia, MI (US)

(72) Inventors: Tai-Lai Ding, Northville, MI (US); Jacob W. Immonen, Livonia, MI (US)

(21) Appl. No.: 17/575,181

(22) Filed: Jan. 13, 2022

(51) Int. Cl. F41G 11/00; G08B 5/36; G08B 3/10; G06F 3/01

(52) U.S. Cl. CPC F41G 11/001; G08B 5/36; G08B 3/10; G06F 3/016

(57) ABSTRACT

A scope alignment assembly is provided that can automatically level a scope. The assembly can include a base defining a hole and including a first scope ring, a spring in the hole, and a detent in the hole, the detent urged toward the scope. The scope mount can include a registration element disposed on a lower portion of the scope, distal from a turret assembly. The detent and/or registration element can be operable in a transition mode in which the detent moves along a scope surface while the scope is rotated about an axis of rotation, and a levelling mode in which the detent is configured to register with the registration element to provide at least one of a visual feedback, an audible feedback and a tactile feedback to indicate the scope is level relative to the base. A related method of use also is provided.

### BACKGROUND OF THE INVENTION

The present invention relates to optical devices, and more particularly to a scope mount alignment assembly to level a scope relative to a firearm.

Many modern sporting, military and hunting firearms are mounted with optics, such as a scope or other magnifying device, to improve viewing and alignment of the firearm with an intended target. Scopes usually include indicia, such as a reticle, crosshairs or other markings viewed by a user through the scope when acquiring a target, to assist in aligning the indicia with the target. The mounting of a scope on a firearm typically should be precise and accurate so that a bullet shot from the firearm follows an intended trajectory. Typically, scope rings are used to mount scopes precisely and in a secured, fixed position relative to the firearm.

When mounting a scope on a firearm, a common challenge is ensuring the reticle is squared to the barrel. For example, in many cases, an installer will try to ensure that the vertical component of a reticle or other sight indicia is perfectly aligned and vertically disposed over the center of the barrel or mount of the firearm. If the vertical component or reticle in general is not properly vertically aligned, then any subsequent vertical or horizontal adjustment of the reticle of the scope will not properly adjust that reticle in a precise vertical or horizontal direction. In contrast, such adjustment will move the reticle along some angle relative to the vertical or horizontal direction that corresponds to the amount by which the vertical component is misaligned relative to vertical, to the barrel or to the mount. As a result, this will affect the sighting in of the weapon to which the scope is mounted, and if not corrected, it will reduce the overall accuracy of shots taken with the firearm while aiming at a target with the misaligned scope.

A variety of techniques are used to level a scope relative to a firearm or mount, however, they require a special skill set and patience. For example, in one technique, a user will apply a bubble level to a mount or component of the firearm and ensure it lays in a horizontal plane. Then, the user will align a vertical component of a reticle with another item that is known to be perfectly vertical, such as a plumb line hung in front of the scope. After alignment, the scope is fastened down in a fixed position relative to the firearm. In another technique, a guide is placed on a mount under the scope, and an alignment wedge is inserted between the mount and a flat surface of a bell or turret on the scope. When the flat surface is aligned with the wedge, the scope is considered level. While such leveling techniques can assist in levelling a scope, they can be cumbersome and complicated to carry out, particularly by users unfamiliar with the process and objective.

Accordingly, there remains room for improvement in the field of levelling scopes relative to weapons.

### SUMMARY OF THE INVENTION

A scope mount is provided that can automatically align and/or level a scope relative to a base of the mount or a weapon to which the scope is mounted.

In one embodiment, the scope mount can include a base including a first registration element urged toward the scope. The scope mount can include a second registration element disposed on a lower portion of the scope, distal from a turret assembly of the scope. The first and second registration elements can be complimentary to one another so that their interface impairs rotation of the scope.

In another embodiment, the scope mount can include a base defining a hole and including a first scope ring, a spring in the hole, and a detent in the hole. The detent can be urged toward the scope.

In still another embodiment, the scope mount can include a registration element disposed on a lower portion of the scope, distal from a turret assembly. Optionally, one registration element can be disposed forward of the turret assembly, and another can be disposed rearward of the turret assembly.

In yet another embodiment, the detent and/or registration element can be operable in a transition mode in which the detent moves along a scope surface while the scope is rotated about an axis of rotation, and a levelling mode in which the detent is configured to register with the registration element to provide at least one of a visual feedback, an audible feedback and a tactile feedback to indicate the scope is level relative to the base.

In even another embodiment, the scope mount can include a detent with a spherical ball configured to roll along the scope surface in the transition mode. The detent can be configured to enter a recess of the registration feature in the levelling mode when level is achieved.

In yet another embodiment, the detent can engage a spring so that the spring is compressed a first amount within the hole in the transition mode. Alternatively, the detent can engage the spring so that the spring is compressed a second amount, lesser than the first amount, within the hole in the leveling mode.

In even another embodiment, the registration element can be an elongated recess that is parallel to an axis of rotation and a longitudinal axis of the scope. In some cases, the elongated recess can include a first recess wall and a second recess wall defining an angle therebetween. The angle can vary depending on the application, as well as the configuration and cross section of the recess.

In a further embodiment, the base can be compatible with a picatinny style rail, in accordance with MIL-STD-1913 (AR) 3 Feb. 1995, which is hereby incorporated by reference in its entirety.

In still a further embodiment, a method of using the scope mount can include providing a base including a first registration element, adjacent a scope ring; rotating a scope relative to the scope ring until a second registration element associated with the scope registers with the first registration element, optionally to provide at least one of a visual feedback, an audible feedback and a tactile feedback indicating that the scope is level relative to the base; and securing the scope with the scope ring in a fixed, levelled position relative to the base and mount.

In yet a further embodiment, a method of using the scope mount can include providing a base defining a hole, adjacent a scope ring, within which a moveable detent is mounted, the detent projecting from a surface of the base; rotating a scope relative to the scope ring until a registration element registers with the detent to provide at least one of a visual feedback, an audible feedback and a tactile feedback to indicate the scope is level relative to the base; and securing the scope with the scope ring in a fixed, levelled position relative to the base and mount after the at least one of a visual feedback, an audible feedback and a tactile feedback is provided.

The current embodiments of the scope mounting assembly provide automatic scope levelling that previously has been unachievable. For example, where the detent engages the registration element, the result can be visual feedback, audible feedback and/or tactile feedback to the user indicating that the scope is leveled upon such feedback. The user need not perform other levelling steps or movements to level the scope to vertical, horizontal or some other plane associated with the mount or weapon. This can take the guess work and subjectivity out of levelling the scope for the user. The user also can be assured that the scope is leveled relative to the mount, weapon and/or an associated barrel thereof. The scope mount can be provided as a kit, with both the scope including the registration element and the mount including the detent, or as individual components, with the scope and mount offered separately.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a perspective view of a scope mount leveling assembly of a current embodiment on a scope on a weapon, with the scope leveled in a levelled mode;

FIG. 2 is a lower perspective view of the scope with registration elements before the scope is placed adjacent one or more scope rings;

FIG. 2A is a close up view of a registration element taken from FIG. 2;

FIG. 3 is a perspective exploded view of a scope ring with a corresponding registration element;

FIG. 4 is a rear section view of the scope mount in a transition mode before the scope is in the levelled mode;

FIG. 5 is a rear section view of the scope mount in the levelled mode with the scope levelled; and

FIG. 6 is a perspective preassembly view of the scope before being installed relative to a single piece mount with integral scope rings of an alternative embodiment.

### DESCRIPTION OF THE CURRENT EMBODIMENTS

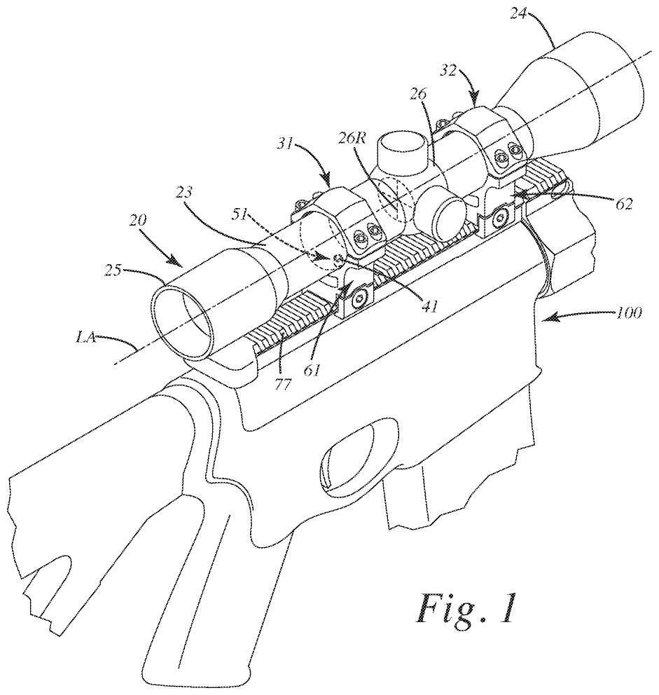

A current embodiment of the scope mount alignment assembly is illustrated in FIGS. 1-5 and generally designated 10. The assembly 10 can be configured to attach a scope 20 to a receiver or frame 102 of a weapon 100. As used herein, a scope can refer to a rifle scope, with or without magnification, a red dot scope, a reflex sight, a holographic sight or any other type of sight having indicia that is beneficial to have leveled relative to the horizon or a reference plane to impair, reduce or prevent cant of the weapon and/or scope. The weapon as shown can be a firearm, such as a rifle, pistol, handgun, shotgun of any type, or an archery device such as a compound bow or crossbow, or other projectile shooting device such as a rocket propelled grenade launcher, a ground-to-air missile launcher, or other device.

As shown in FIG. 1, the assembly 10 can include a first scope ring 31 and a second scope ring 32. These scope rings can engage the scope at the barrel or scope tube 23 of the scope distal from one another. The scope tube can be cylindrical tube extending forward and aft of a turret assembly 26 of the scope, which can include windage adjustment 26W and elevation adjustment 26E to adjust the reticle 26R. Generally, the cylindrical, curved or rounded surfaces of the scope tube can extend between the eyepiece 25 and the turret 26, and between the objective 24 and the turret 26. The turret thus can interrupt all or a portion of those cylindrical surfaces.

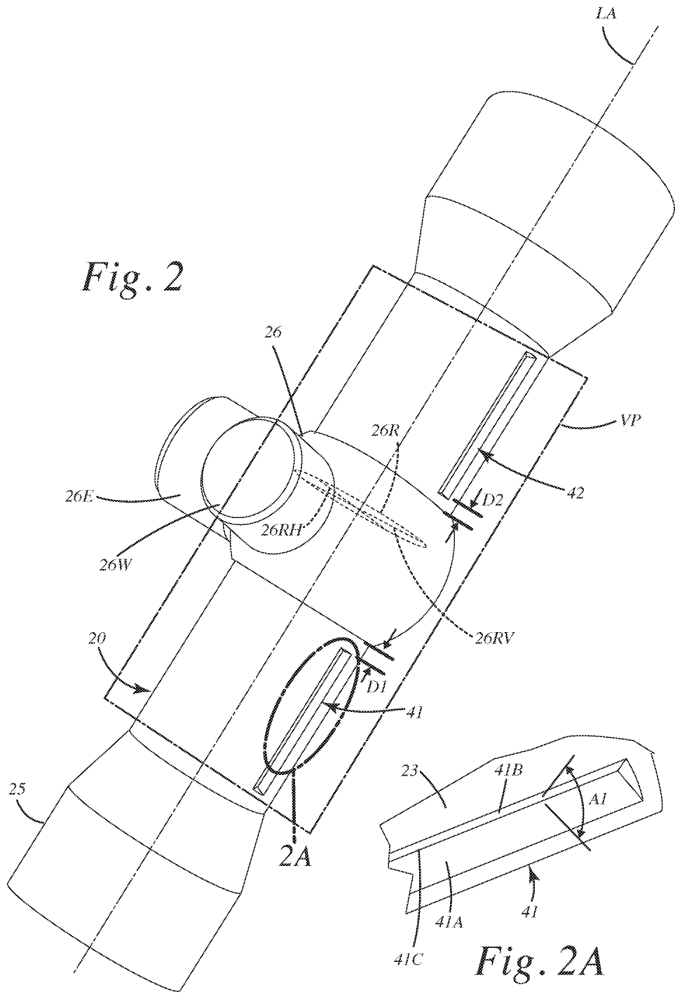

The details of the scope associated with the assembly 10 are shown further in FIGS. 2 and 2A. There, the scope 20 can include the reticle 26R as mentioned above. The reticle can include a vertical line or other vertical reticle indicia 26RV and a horizontal line or horizontal reticle indicia 26RH. The vertical reticle indicia can be perfectly aligned with a vertical reference plane VP and can extend in that plane. This plane can be calibrated so that it is perfectly vertical when the reticle is leveled to vertical as described below.

The scope can further include first and second registrations elements 41 and 42 which are also centered on and aligned with the vertical reference plane VP, and thus correspondingly aligned perfectly with the vertical reticle indicia 26RV. Although shown as two registration elements, more or fewer registration elements can be included on the scope. The registration elements can be disposed on a lower portion 23L of the scope, and in particular, along the curved, rounded and/or cylindrical surfaces of the scope tube. These elements 41 and 42 can be distal from the turret assembly, and longitudinally offset from a lowermost surface 26L of the turret. Accordingly, the turret, the lowermost surface and its components optionally do not interfere with rotation of the scope about an axis of rotation or a longitudinal axis LA, which can be parallel, coincident or aligned with one another.

As further shown in FIGS. 2 and 2A, the registration elements 41 and 42 can straddle the turret assembly 26 and lower surface 26L longitudinally. These registration elements can be optionally in the form of elongated recesses 41R and 42R that can be parallel to the axis of rotation and a longitudinal axis LA of the scope, and can lay in the vertical plane VP. The elongated recesses can be similar for both the first and second 41 and 42 registration elements, differing only in location, so only the first registration element 41 will be described here. In particular, as shown in FIG. 2A, the recess 41 can include a first recess wall 41A and a second recess wall 41B defining an angle A1 therebetween, and joined at an apex 41C. As shown, the angle A1 can be an obtuse angle, but optionally can be a right angle or in some cases an acute angle. The recess walls 41A and 41B can planar, curved, rounded, contoured, or can have other shapes and undulations formed on the optionally curved, rounded and/or cylindrical surfaces (all referred to as cylindrical surfaces) included in the scope tube 23 or cylindrical tube of the scope. In some cases, the registration elements can be formed as U or V shaped channels. Optionally, the registration elements 41 and/or 42 can be formed as flat or planar surfaces on the cylindrical surface of the tube. The corresponding registration elements 51 and 52 of the scope rings and their bases can be shaped, sized and contoured to engage such registration elements 41 and 42 and automatically align the vertical sight indicia in the vertical plane as described below.

As mentioned above, the cylindrical tube 23 of the scope can include the vertical reference plane VP passing through a longitudinal axis LA of the scope, and aligned with the vertical reticle indicia 26RV. That vertical reference plane VP can intersect the cylindrical tube under the longitudinal axis LA at a 6 o'clock position 6O, when considering the longitudinal axis LA. The registration elements 41 and 42 can also be disposed at and perfectly centered on the 6 o'clock position 6O. Of course, in other constructions, the registration elements 41 and 42 can be disposed at other positions, such as a 5 o'clock position, a 4 o'clock position, a 7 o'clock position, an 8 o'clock position or other positions that will register with the corresponding registration elements 51, 52 of the scope rings 31 and 32, assuming each includes such registration elements as described below.

The scope alignment assembly 10 shown in FIGS. 1-3 can include a first scope ring 31 and a second scope ring 32. These mount rings can include similar structures and corresponding registration elements, so only the first scope ring will be described here, noting that the second ring can be identical, but optionally placed distal from, the first ring. Also, in some cases, where only one set of registration elements 41 and 51 are used to level the scope to the vertical reference plane VP, the other registration elements on the other scope ring can be absent from the assembly, In some cases, have redundant corresponding registration elements on the rings and scope can optionally improve the alignment of the vertical reticle indicia 26RV with the vertical reference plane to level the scope faster relative thereto.

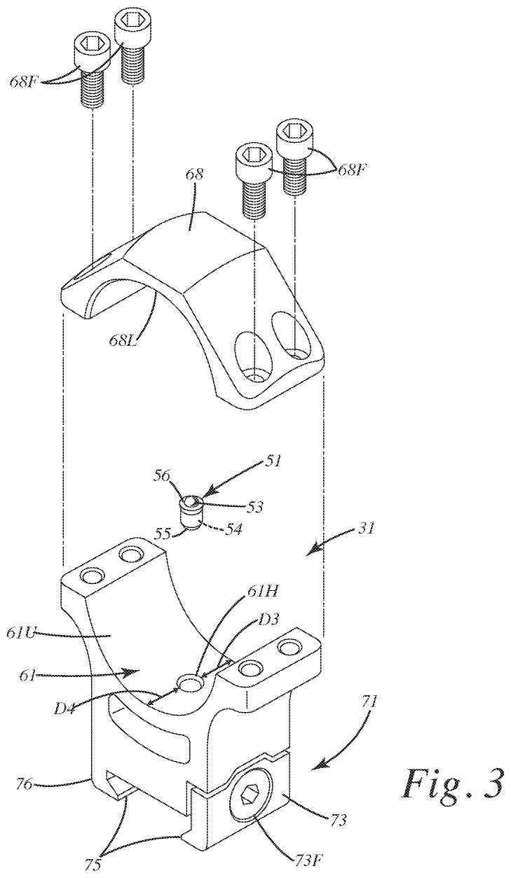

As shown in FIG. 3, a first base 61 can define a hole 61H that extends toward the scope 20 when the scope is mounted in the first scope ring 31. The hole 61H can be defined in an upper surface 61U of the base 61. This upper surface can be curved, rounded and or contoured to correspond to the cylindrical surfaces of the scope tube so that the scope tube can rotate about the longitudinal axis LA of the scope within the scope ring freely as described below in a transition mode. The hole can take on a similar curved or contoured perimeter of the upper surface 61U. The hole 61H can be inset a first distance D3 and a second distance D4 from the front and rear surfaces of the base 61. These distances can optionally be equal so the detent or registration feature is centered from front to back of the base 61.

The base 61 can be joined with a connector 71 which as shown can be in the form of a clamp having a movable clamp part 73 moved by a fastener 73F relative to another connector portion 76. This connector can include rails 75 configured to allow the base to be secured to a corresponding rail 77 associated with the weapon 100. This rail can be any type of connecting rail, for example a weaver type rail or a picatinny style rail, in accordance with MIL-STD-1913 (AR) 3 Feb. 1995. Whatever type of connector and rail are used can be constructed with good tolerances to ensure the scope ring and base mount firmly, consistently and repeatedly to the rail, and so that after the assembly 10 self aligns the reticle and scope to the scope rings and weapon, the alignment is maintained.

With further reference to FIG. 3, the base can extend up to a cap 68, which can be secured to the base via fasteners 68F. More or fewer fasteners can be included. Optionally, the lower surface 68L can face toward the scope when installed in the scope ring 31.

The registration element 51 can include a bias element, which can be in the form of a spring 54 mounted in a cup 55, which can be further mounted in the hole 61H. A detent 53 can be captured with a flange 56 in the cup 55. The detent 53 can be urged toward the scope by the spring 54 when the scope is mounted in the ring 31 and projecting from the upper surface 61U thereof. The spring 54 can be a coil spring as shown or any other type of biasing element, such as a compliant bumper, a leaf spring, or a magnet, all of which can be referred to as a spring herein. As shown, the detent 53 can include a spherical ball configured to roll along the scope surface in the transition mode. Of course, the detent can take on other contours or shapes and can slide or otherwise move along the scope surface 23 in the transition mode as described below. The detent 53 also can be configured to engage, contact and/or enter the registration elements 41 of the scope as described below in a levelling mode.

Optionally, the registration element 51, and optionally the cup 55 with the detent and spring therein, can be press fit, glued, cemented or threaded into the hole 61H in the base under exacting tolerances to ensure precise self-alignment of the scope relative to the rings, and thus the reticle relative to the vertical reference plane VP or some other plane depending on the application.

The scope alignment assembly can be configured to provide feedback to a user to indicate when the system achieves a levelling mode, that is, when the scope is level relative to the base, the ring, or the weapon, and optionally when the vertical reticle indicia 26RW is parallel to or lays within the vertical reference plan VP. The alignment feedback in the levelling mode can be provided in a number of formats. For example, the alignment can be verified by a user optionally via at least one of a visual feedback, an audible feedback and/or a tactile feedback to indicate the scope 20 is level relative to the bases, rings, and/or the weapon to which the scope is mounted, with the vertical reticle indicia parallel to and/or aligned with the vertical reference plane VP. The visual feedback can be viewed by a user to see that the registration elements are aligned and/or registered with one another. The audible feedback can be heard by the user when the elements are aligned, and can be in the form of a click, snap, tick or other audible output. The tactile feedback can be a vibration, oscillation or small impact or irregularity felt through the scope and/or the rings by a user.

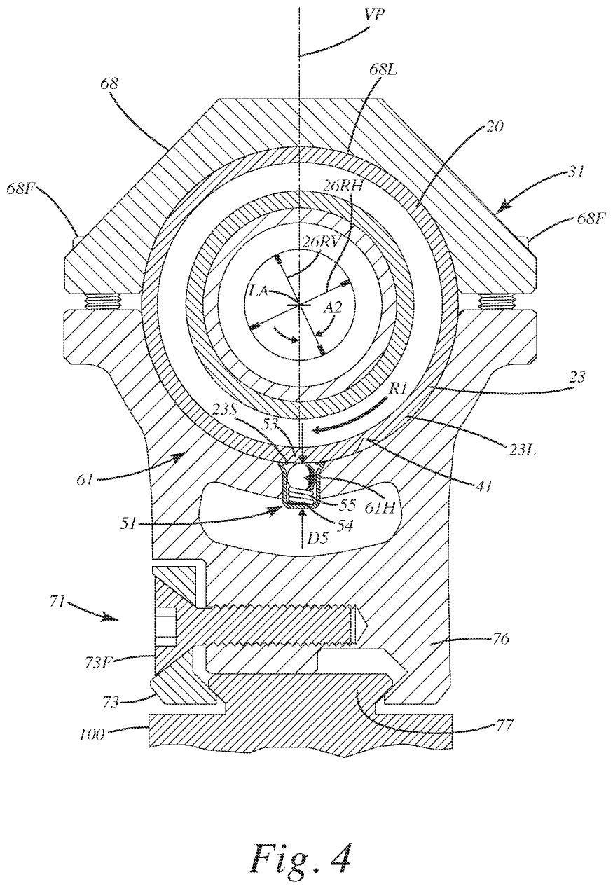

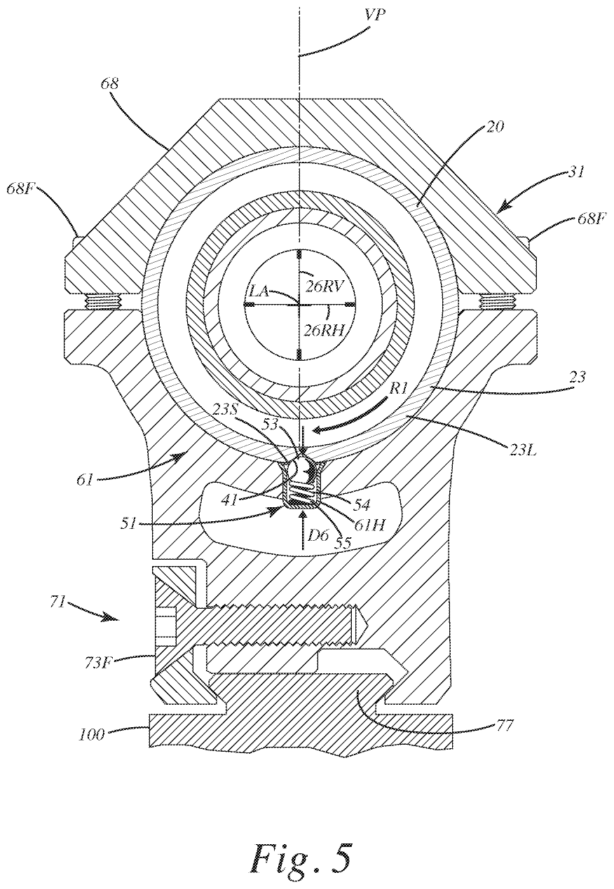

Before the scope alignment assembly is in the levelling mode, it can be in a transition mode. In this transition mode, the registration elements, for example, the detent 51 and recess 41 have not yet engaged one another, and thus have not achieved a condition where the scope is level relative to the base 61, or where the vertical reticle indicia 26RW is not yet aligned with and/or parallel to the vertical reference plane VP. The transition mode and the levelling mode are better illustrated in FIGS. 4 and 5 respectively. As shown in FIG. 4, the scope 20 is shown initially installed in the rings 31 and 32, although this figure primarily shows only the first scope ring 31. The cap 68 of the ring 31 can be tightened down to the base 61 with the fasteners 68F snugly, but loose enough that the scope tube 23 can still be rotated about the longitudinal axis LA, which can form an axis of rotation as well. The base 61 also can be secured to the rail 77 of the weapon 100 in a fixed manner with the connector as described above. In this transition mode, it can be seen that the vertical reticle indicia 26RW is offset at some angle A2 relative to the vertical plane VP. In such a case, it is known that the scope is not yet level to the base or the weapon, optionally via inspection or by the user not having experienced the feedback described herein.

In the transition mode shown in FIG. 4, the detent can move along the scope surface while the scope 20 is rotated in direction R1 (or an opposite direction, depending on the initial alignment) about the axis of rotation or longitudinal axis LA. Conversely, the registration element can move toward the detent 53 while the scope is rotated about an axis of rotation. Where the detent optionally includes a spherical ball 53, that ball can roll along the smooth, rounded, curved or cylindrical surface 23S of the scope tube 23. In this transition mode, the detent 53 engages the spring 54 within the cup 55 so that the spring is compressed a first amount. For example, the overall length of the spring 54 in the transition mode can be a distance D5. After the detent and assembly 10 in general achieve the levelling mode in FIG. 5, the detent engages the spring so that the spring is compressed a second amount, lesser than the first amount. For example, the overall length of the spring 54 in the transition mode can be a distance D6, which can be greater than distance D5. Optionally, the registration feature 41 likewise can transition from a lesser length D5 in the transition mode to a greater length D6 in the levelling mode. In the levelling mode the detent can enter, register with or engage the registration element 41 of the scope, which can facilitate or allow the increase in distance or length. Where the registration element is the elongated recess 41, the detent can at least partially enter that recess, and extend farther from the cup 55, thereby allowing the spring to extend in length.

When the detent 53 enters the registration element 41 after moving through the transition mode to the levelling mode, as mentioned above, the interfacing of these elements can provide visual feedback, audible feedback and/or tactile feedback to indicate the scope is level relative to the base. In the levelling mode, the vertical reticle indicia 26RW self aligns with the vertical reference plane VP, so the two are parallel, as shown in FIG. 5. As also shown there, and referring back to FIG. 2A, the detent 53, when in the form of a ball, can contact the opposing walls 41A and 41B of the elongated recess or registration feature 41. The ball, however, likely will not contact the apex 41C of the recess, unless the walls are of a similar curvature as the ball.

A method of using the scope alignment assembly 10 will now be generally described. On a high level, the method can include providing a base including a first registration element, adjacent a scope ring; rotating a scope relative to the scope ring until a second registration element associated with the scope registers with the first registration element, optionally to provide at least one of a visual feedback, an audible feedback and a tactile feedback indicating that the scope is level relative to the base; and securing the scope with the scope ring in a fixed, levelled position relative to the base and mount.

More particularly, with reference to FIGS. 1-5, the method can include providing one or more bases 61, 62 adjacent one or more scope rings 31, 32. One or more moveable detents can be mounted in corresponding holes of the bases, where the detents project from a surface of the bases 61, 62. The bases 61, 62 can be spaced from one another along the scope tube 23 and secured to a rail or mount 77 of the weapon 100 with the connector. The bases can be offset and distal from the turret assembly 26 of the scope, and positioned forward and rearward of that turret assembly 26. The scope 20 can be rotated relative to the scope rings 31, 32 in a transition mode, described in connection with FIG. 4 above. Rotation can continue until one or more registration elements 41, 42 on the scope, which are aligned with the vertical reticle indicia 26RW of the reticle 26, register with the detents to automatically align the vertical reticle indicia 26RW with the vertical reference plane VP in the levelling mode, described in connection with FIG. 5 above. When this occurs, such registration can provide at least one of a visual feedback, an audible feedback and a tactile feedback to indicate the scope is level relative to the bases. After such feedback, the user can tighten further the fasteners 58F, thereby securing the scope caps down against the scope tube and impairing further rotation or movement of the scope relative to the rings.

Optionally, the scope 20 can be removed from the rings 31, 32 at a later time for service, repair or updating of the scope. The above method can be repeated when reinstalling the scope to again easily and automatically self-align the scope relative to the base and weapon in general, so the vertical reticle indicia 26RW is parallel to the vertical reference plane VP. It will be further appreciated that the assembly 10 can come in a kit, with the scope and its registration elements, as well as the scope rings and their corresponding registration elements. In some cases, however, only the scope 20 with its registration elements might be offered alone, to fit existing scope rings. In other cases, the scope rings 31, 32, with respective registration elements, might be offered alone, to fit an existing scope with corresponding registration elements.

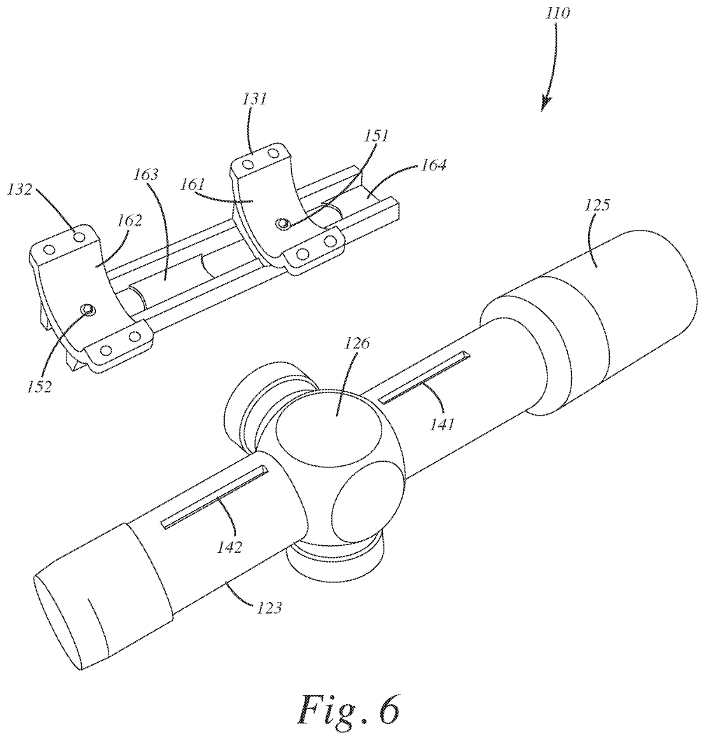

A first alternative embodiment of the scope alignment assembly is shown in FIG. 6 and generally designated 110. This embodiment is similar to the above embodiment in structure, function and operation, with several exceptions. For example, this embodiment can include a scope having an eyepiece 128, a scope tube 123 which can be cylindrical, a turret assembly 126, and first 141 and second 142 registration elements located forward and rearward of the turret assembly. The scope rings 131 and 132 can include bases 161 and 162 that are integrally connected with a bridge 163 to form a single piece scope mount 164. The bases 161 and 162 can include the detents 151 and 152 and can be operable in the transition mode and levelling mode as described above when cooperating with the registration elements 141 and 142. Installation and alignment of the scope relative to vertical with this embodiment can be similar to the embodiment above.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

In addition, when a component, part or layer is referred to as being “joined with,” “on,” “engaged with,” “adhered to,” “secured to,” or “coupled to” another component, part or layer, it may be directly joined with, on, engaged with, adhered to, secured to, or coupled to the other component, part or layer, or any number of intervening components, parts or layers may be present. In contrast, when an element is referred to as being “directly joined with,” “directly on,” “directly engaged with,” “directly adhered to,” “directly secured to” or “directly coupled to” another element or layer, there may be no intervening elements or layers present. Other words used to describe the relationship between components, layers and parts should be interpreted in a like manner, such as “adjacent” versus “directly adjacent” and similar words. As used herein, the term “and/or” includes any and all combinations of one or more of the associated listed items.

The above description is that of current embodiments of the invention. Various alterations and changes can be made without departing from the broader aspects of the invention as defined in the appended claims, which are to be interpreted in accordance with the principles of patent law, including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. Any reference to claim elements as “at least one of X, Y and Z” is meant to include any one of X, Y or Z individually, any combination of X, Y and Z, for example, X, Y, Z; X, Y; X, Z; Y, Z, and/or any other possible combination together or alone of those elements, noting that the same is open ended and can include other elements.

What is claimed is:

1. A method of aligning a scope relative to a weapon, the method comprising;
providing a base adjacent a scope ring with which a moveable detent is joined, the detent projecting from a surface of the base;
rotating a scope relative to the scope ring until a registration element registers with the detent to provide at least one of a visual feedback, an audible feedback and a tactile feedback to indicate the scope is level relative to the base; and
securing the scope with the scope ring in a fixed, levelled position relative to the base and mount after the at least one of a visual feedback, an audible feedback and a tactile feedback is provided.

2. The method of claim 1,
wherein the detent is urged upward toward a curved surface of the scope by a spring plunger while the scope is rotated.

3. The method of claim 2,
wherein the detent enters the registration element thereby causing the at least one of a visual feedback, an audible feedback and a tactile feedback.

4. The method of claim 1,
wherein the scope includes a turret assembly and a cylindrical tube,
wherein the registration feature is mounted to the scope distal from the turret assembly,
wherein the detent moves along a curved surface of the cylindrical tube distal from the turret assembly.

5. The method of claim 1,
wherein a spring in a hole defined by the base urges the detent to an extended mode when the detent enters the registration feature.

6. The method of claim 1,
wherein a spring contacting the detent is compressed while the detent engages a cylindrical portion of the scope,
wherein the spring is less compressed when the detent engages the registration feature.

7. The method of claim 6,
wherein the detent is distal from a turret assembly of the scope having a flat lower surface.

8. The method of claim 1,
wherein the detent includes a spherical ball that engages a spring in a hole in the base.

9. The method of claim 1,
wherein the registration feature is an elongated recess defined in a wall of the scope,
wherein the detent at least partially enters the elongated recess to provide the at least one of a visual feedback, an audible feedback and a tactile feedback.

10. The method of claim 1,
wherein the detent moves along a wall of the scope as the scope rotates until the detent enters a recess to provide the at least one of a visual feedback, an audible feedback and a tactile feedback.

11. A scope alignment assembly comprising:
a base including a first scope ring, the base defining a hole that extends toward a scope when the scope is mounted in the first scope ring;
a spring mounted in the hole; and
a detent mounted in the hole adjacent the spring, the detent being urged toward the scope and projecting from a surface,
wherein the detent is operable in a transition mode in which the detent moves along a scope surface while the scope is rotated about an axis of rotation,
wherein the detent is operable in a levelling mode in which the detent is configured to register with a registration element of the scope to provide at least one of a visual feedback, an audible feedback and a tactile feedback to indicate the scope is level relative to the base.

12. The scope alignment assembly of claim 11,
wherein the detent includes a spherical ball configured to roll along the scope surface in the transition mode.

13. The scope mount of claim 12,
wherein the detent is configured to enter a recess of the registration feature in the levelling mode.

14. The scope alignment assembly of claim 11,
wherein the detent engages the spring so that the spring is compressed a first amount within the hole in the transition mode,
wherein the detent engages the spring so that the spring is compressed a second amount, lesser than the first amount, within the hole in the leveling mode.

15. The scope alignment assembly of claim 11,
wherein the base includes a second scope ring distal from the first scope ring,
wherein the hole is disposed between the first scope ring and the second scope ring,
wherein the hole is offset from a location where a turret assembly surface of the scope is configured to be placed.

16. A scope alignment assembly comprising:
a scope having a scope tube, an eye piece and a turret assembly along the scope tube; and
a registration element disposed on a lower portion of the scope tube distal from the turret assembly,
wherein the registration element is operable in a transition mode in which the registration element moves toward a detent while the scope is rotated about an axis of rotation,
wherein the registration element is operable in a levelling mode in which the registration element is configured to engage the detent to provide at least one of a visual feedback, an audible feedback and a tactile feedback to indicate the scope is level relative to the base.

17. The scope alignment assembly of claim 16,
wherein the registration element is an elongated recess that is parallel to the axis of rotation and a longitudinal axis of the scope.

18. The scope alignment assembly of claim 17,
wherein the elongated recess includes a first recess wall and a second recess wall defining an obtuse angle therebetween.

19. The scope alignment assembly of claim 16,
wherein the scope tube is a cylindrical tube,
wherein the cylindrical tube includes a vertical reference plane passing through a longitudinal axis of the scope,
wherein the vertical reference plane intersects the cylindrical tube under the longitudinal axis at a 6 o'clock position,
wherein the registration element is disposed at the 6 o'clock position.

20. The scope alignment assembly of claim 19,
wherein the registration element is an elongated recess including a first recess wall and a second recess wall that are at least one of curved and angled relative to one another.
